(19) United States
(12) Patent Application Publication
(10) Pub. No.: US 2003/0070177 A1
(43) Pub. Date: Apr. 10, 2003

(54) Computer program product for TV telephone system

(75) Inventors: Takashi Kondo, Sakai-shi (JP); Yong Xin Huang, Kobe-shi (JP)

Correspondence Address: SIDLEY AUSTIN BROWN & WOOD LLP, 717 NORTH HARWOOD, SUITE 3400, DALLAS, TX, 75201, US

(73) Assignee: Minolta Co., Ltd

(21) Appl. No.: 10/266,974

(22) Filed: Oct. 8, 2002

(30) Foreign Application Priority Data
Oct. 10, 2001 (JP) P2001-312836

(51) Int. Cl. H04N 7/18; H04N 7/173; H04N 7/14; H04N 9/47

(52) U.S. Cl. 725/106; 725/78; 725/133; 725/81; 348/80; 348/14.1

(57) ABSTRACT

There is provided a controller capable of effectively using a camera in a TV telephone system and a technique related to the same.

A server controls a TV telephone system including stationary cameras and a portable telephone having a built-in camera. The server can perform a short-range radio communication with the portable telephone and can perform a communication with the stationary cameras and the like via a household network. The server can receive a video signal from the built-in camera and a video signal from the stationary cameras. The server selects one of the video signals as a video signal to be transmitted to the other party of the portable telephone, and transmits the selected video signal to the other party of the portable telephone during a call of the portable telephone. The stationary cameras also function as a monitor camera.

This application is based on application No. 2001-312836 filed in Japan, the contents of which are hereby incorporated by reference.

### BACKGROUND OF THE INVENTION

1. Field of the Invention

The present invention relates to a controller of a TV telephone system and a technique related to the same.

2. Description of the Background Art

In a conventional TV telephone system, a video image is often transmitted by using a relatively-large fixed camera having a relatively high resolution.

As a portable telephone is spread and its communication speed is improved in recent years, a TV telephone system using a portable telephone (hereinafter, also referred to as a “portable TV telephone”) is being practically used. In such a portable telephone, a reception video image transmitted from the other party is displayed on a liquid crystal display or the like (display unit) and a video image captured by a camera (image pickup unit) having a relatively low resolution provided for the portable telephone is transmitted to the other party.

However, due to low resolution of the camera provided for the portable telephone, such a portable TV telephone has a problem that the quality of a captured video image cannot be sufficiently assured like the case where it is difficult to capture a picture from which a subtle expression of the other party can be seen. On the other hand, in the case of providing a relatively large and relatively high resolution camera separately from a portable telephone, portability is lost. Due to a narrow range of selection such that a proper camera cannot be selected according to a situation, there is a problem that the camera cannot be effectively used.

Further, it is not efficient to provide a camera having a high resolution just for the purpose of an image capturing function in the TV telephone system. Consequently, in the case of providing a camera separately from a portable telephone, it is important to effectively use the camera.

Such a problem can occur not only in the portable TV telephone but also generally in a TV telephone system. A technique of effectively using a camera in a general TV telephone system is therefore required.

### SUMMARY OF THE INVENTION

An object of the present invention is to provide a controller capable of effectively using a camera in a television telephone system, and a technique related to the same.

The present invention is directed to a software product.

According to the present invention, in a program product which can be read by a computer provided in a controller of a television telephone system including a telephone having a first camera, and a second camera, the program product includes the instructions of: selecting, as a video signal to be transmitted to the other party of the telephone, one of a video signal from the first camera and a video signal from the second camera; and transmitting the selected video signal to the other party of the telephone during a call of the telephone.

With the configuration, selection of video images transmitted to the other party is widened. In other words, by properly using the first and second cameras, each of the cameras can be effectively utilized.

Preferably, the program product can switch a display target of the reception video image transmitted from the other party between the first and second display devices during a call by the telephone.

With the configuration, the reception video image can be displayed on not only the first display device provided for the telephone but also the second display device, so that the selection is widened.

Preferably, when the video signal from the second camera is selected as a video signal to be transmitted to the other party of the telephone, the reception video image transmitted from the other party is displayed on the second display device.

With the configuration, the second camera and the second display device can be used as a set of image pickup and display system in the television telephone system.

According to another aspect of the present invention, in a program product which can be read by a computer provided in a controller of a television telephone system including a telephone and a camera provided separately from the telephone, the program product includes the instructions of: determining whether radio communication can be performed between the controller and the telephone; and switching an operation mode of the camera to a monitoring mode in which the camera is used as a monitor camera when the radio communication cannot be performed between the telephone and the controller.

With the configuration, the camera can be effectively used.

According to still another aspect of the present invention, in a program product which can be read by a computer provided in a controller of a television telephone system having a camera, the program product includes the instructions of: determining whether the operator requests setting of a monitor mode in which the camera is used as a monitor camera or not; and switching an operation mode of the camera to the monitor mode when the operator requests setting of the monitoring mode.

With the configuration, the camera can be effectively used.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing the configuration of a TV telephone system according to a first embodiment of the present invention;

FIG. 2 is a functional block diagram showing the configuration of a server;

FIG. 3 is a functional block diagram showing the configuration of a portable telephone;

FIG. 4 is a functional block diagram showing the configuration of a camera;

FIG. 5 is a functional block diagram showing the configuration of a TV;

FIG. 6 is a flowchart showing operations of the server;

FIG. 7 is a flowchart showing operations of the server which received “a stationary camera ON signal”;

FIG. 8 is a flowchart showing operations of the server which received “a stationary camera OFF signal”;

FIG. 9 is a flowchart showing operations of the portable telephone;

FIG. 10 is a flowchart showing operations of the camera;

FIG. 11 is a flowchart showing operations of the TV;

FIG. 12 is a flowchart showing operations of the server related to a monitoring mode;

FIG. 13 is a flowchart showing operations of the camera related to the monitoring mode;

FIG. 14 is a flowchart showing operations of the server which received a notification of an abnormal state;

FIG. 15 is a diagram showing the configuration of a portable telephone according to a second embodiment;

FIG. 16 is a flowchart showing operations of the portable telephone according to the second embodiment; and

FIG. 17 is a flowchart showing operations of the camera according to the second embodiment.

### DESCRIPTION OF THE PREFERRED EMBODIMENTS

Embodiments of the present invention will be described hereinafter with reference to the drawings.

A. First Embodiment

A1. System Configuration

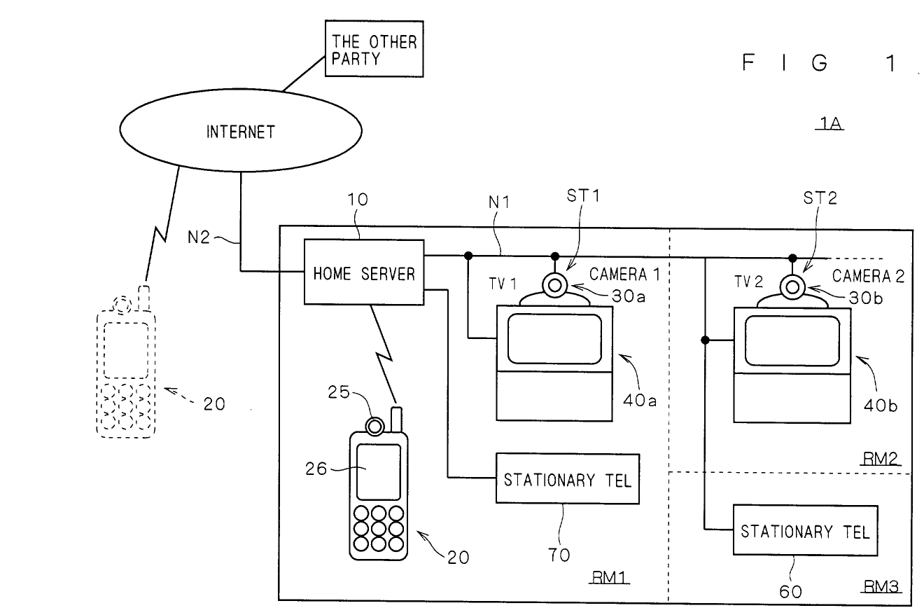

FIG. 1 is a schematic diagram showing the configuration of a TV telephone system 1A according to a first embodiment of the present invention.

The TV telephone system 1A includes a server 10, a portable telephone 20, camera TV sets ST1 and ST2, a stationary-type TV telephone (hereinafter, also referred to as a stationary TV telephone or a stationary telephone) 60, and a stationary-type telephone (hereinafter, also referred to as a stationary telephone) 70. These devices are not always necessary to be disposed in one habitable room (a room) but may be separately disposed in different rooms in a house. Description will be given with respect to a case where the devices are disposed as follows. More specifically, the server 10, the camera TV set ST1 and the stationary telephone 70 are disposed in a room RM1, the camera TV set ST2 is disposed in a room RM2, and the stationary TV telephone 60 is disposed in a room RM3. The existence position of the portable telephone 20 frequently varies since the portable telephone 20 is carried by the operator.

The camera TV set ST1 has a camera 30a used as an image pickup device for capturing a video image around the installation position of the camera 30a, and a TV receiver (hereinafter, also simply referred to as a “TV”) 40a used as a display for displaying not only a video image of a received TV broadcast but also other various video images. The camera TV set ST2 also has a configuration similar to that of the camera TV set ST1 and has a camera 30b and a TV 40b.

As will be described hereinafter, since the camera TV set ST1 is used as a part of a TV telephone, it is preferable to dispose the camera 30a and the TV 40a close to each other. It is preferable that, for example, the camera 30a is disposed in a position close to the TV 40a such as a position just above the TV 40a for the following reason. Since the speaker (talker) looks at the TV 40a to see a video image displayed on the TV 40a, the camera 30a disposed close to (for example, just above) the TV 40a can capture an image of the speaker (talker) from the front. The camera 30b and the TV 40b of the camera TV set ST2 are disposed similarly.

A2. Server 10

The server 10 is connected to the portable telephone 20, the camera TV sets ST1 and ST2, the stationary TV telephone 60, and the stationary telephone 70 via a household network N1, and controls the devices via the household network N1. Therefore, the server 10 can be also referred to as a home server. The server 10 is also connected to an external network N2 such as so-called the Internet and plays a role of mediating between the household network N1 and the external network N2. Plainly, the server 10 functions as a window of communication with the outside.

The “network” denotes a communication line network for performing data transmission and is, concretely, any of various communication line networks constructed by an electric communication line (including an optical communication line) such as the Internet, LAN, WAN and CATV. As necessary, the “network” will called as while distinguishing the household network (a kind of an LAN) N1 and the external network N2 from each other.

As will be described hereinafter, communication can be performed between the portable telephone 20 and another device at the other party (telephone, computer or the like) via the network. Concretely, a call or the like using the IP (Internet Protocol) can be made.

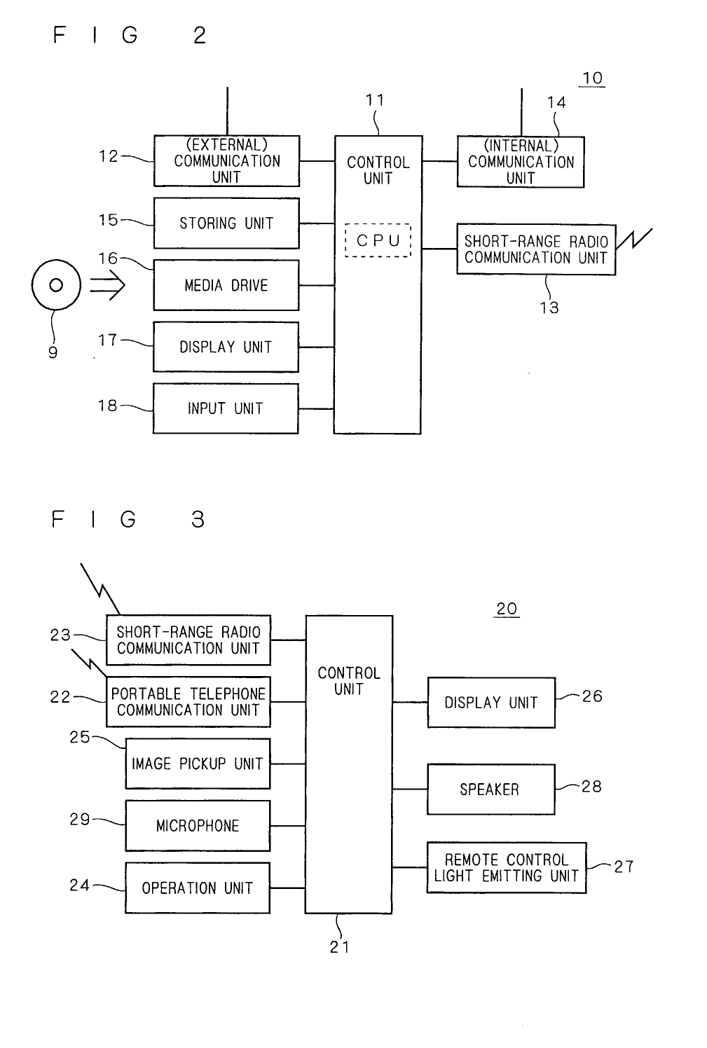

FIG. 2 is a functional block diagram showing the configuration of the server 10.

The server 10 is constructed as a computer system (also simply referred to as a “computer”) provided with a control unit 11 including a CPU, communication units 12, 13 and 14 including a network card or the like, a storing unit 15 having a main storing unit taking the form of a semiconductor memory such as a RAM (and/or a ROM) and an auxiliary storing unit such as a hard disk drive (HDD), a media drive 16, a display unit 17 such as a display, and an input unit 18 such as a keyboard and a mouse.

Among the communication units 12, 13 and 14, the communication unit 12 is a communication unit for performing communication with an external device via the external network N2. The communication unit 14 is a communication unit for performing communication with the devices ST1, ST2, 60 and 70 via the household network N1. The communication unit 13 is a communication unit for performing communication with the portable telephone 20 by short-range radio communication such as Bluetooth (trademark) and will be also referred to as a short-range radio communication unit 13. The server 10 is constructed so as to transmit/receive a command and data to/from other devices by radio or wired data communication or the like via the communication units 12, 13 and 14.

The media drive 16 reads out information recorded in a portable recording medium 9 such as a CD-ROM, DVD (Digital Versatile Disk), flexible disk or memory card.

The server 10 reads a software program (hereinafter, simply referred to as a “program”) recorded on the recording medium 9 and, by executing the program by using the CPU or the like, functions as a controller of the TV telephone system 1A. The present invention is not limited to the case where the program is supplied (or distributed) via the recording medium 9. Such a program may be supplied (or distributed) to the server 10 via a network such as the Internet.

A3. Portable Telephone 20

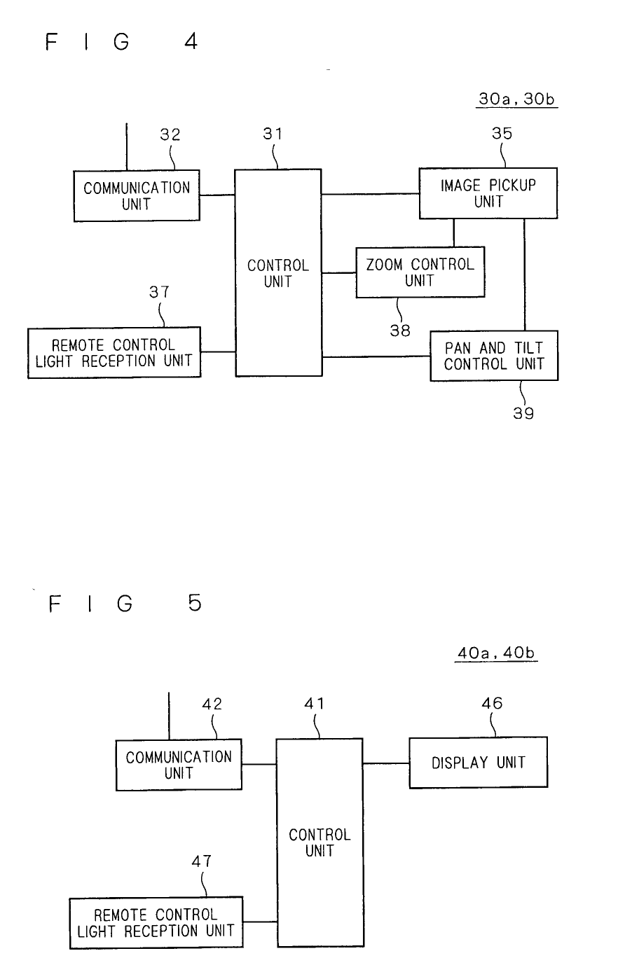

FIG. 3 is a functional block diagram showing the configuration of the portable telephone 20. As shown in FIG. 3, the portable telephone 20 has a control unit 21, a portable telephone communication unit 22, a short-range radio communication unit 23, an operation unit 24, an image pickup unit 25, a display unit 26, a remote control light emitting unit 27, a speaker 28, and a microphone 29.

The control unit 21 is constructed by a CPU and the like and is a function unit for controlling the function parts of the portable telephone 20.

The speaker 28 is used as a sound output unit for outputting sound from the other party and the microphone 29 is used as a sound input unit for receiving sound of the speaker (talker) of the portable telephone 20. The image pickup unit 25 takes the form of a CCD camera or the like having a relatively low resolution (for example, approximately 100000 pixels). The display unit 26 takes the form of a liquid crystal display having a relatively small screen (for example, approximately 100000 pixels) or the like. The image pickup unit 25 (hereinafter, also referred to as a “camera 25”) can take an image of the speaker (talker) of the portable telephone 20. The display unit 26 (hereinafter, also referred to as “display 26”) can display a video image transmitted from the other party of the portable telephone 20. Therefore, the combination of the camera 25 and the display 26 can function as a part of the TV telephone system capable of performing bi-directional communications of transmitting/receiving video images. Sound can be inputted/outputted by using the speaker 28 and microphone 29.

The portable telephone 20 has the following two kinds of radio communication functions. One is a communication function as a normal radio portable telephone for performing communication via a base station, and the other is a communication function of performing communication with the server 10 by short-range radio communication such as Bluetooth (trademark).

When the portable telephone 20 exists outdoor and the distance between the portable telephone 20 and the server 10 exceeds a predetermined range (in the position indicated by a broken line in FIG. 1), the portable telephone 20 cannot perform the short-range radio communication with the server 10 but can use a normal function of the portable telephone. Specifically, a communication function of performing portable telephone communication using radio communication with a base station provided by a portable telephone company or the like. In the case of a call, a telephone number assigned to the portable telephone 20, in other words, a telephone number peculiar to the portable telephone 20 is used. By using the communication function, not only usual calls but also browsing on the Internet can be made. The portable telephone communication unit 22 is a function unit for performing the portable telephone communication.

On the other hand, when the distance between the portable telephone 20 and the server 10 is within a predetermined range (for example, about 10 m), the portable telephone 20 can perform short-range radio communication with the server 10. As a result, for example, when the portable telephone 20 exists in the house (indoor), the portable telephone 20 can make a call and transmit data by the short-range radio communication with the server 10. At the time of a call, not the telephone number assigned to the portable telephone 20 but telephone numbers assigned to the stationary telephones 60 and 70 are used. The portable telephone 20 functions as a slave telephone of the stationary telephones 60 and 70 under control of the server 10. The short-range radio communication unit 23 is a function unit for performing the short-range radio communication. The various operations will be described hereinafter mainly with respect to the case where the portable telephone 20 exists within a predetermined distance range from the server 10, that is, the short-range radio communication is used.

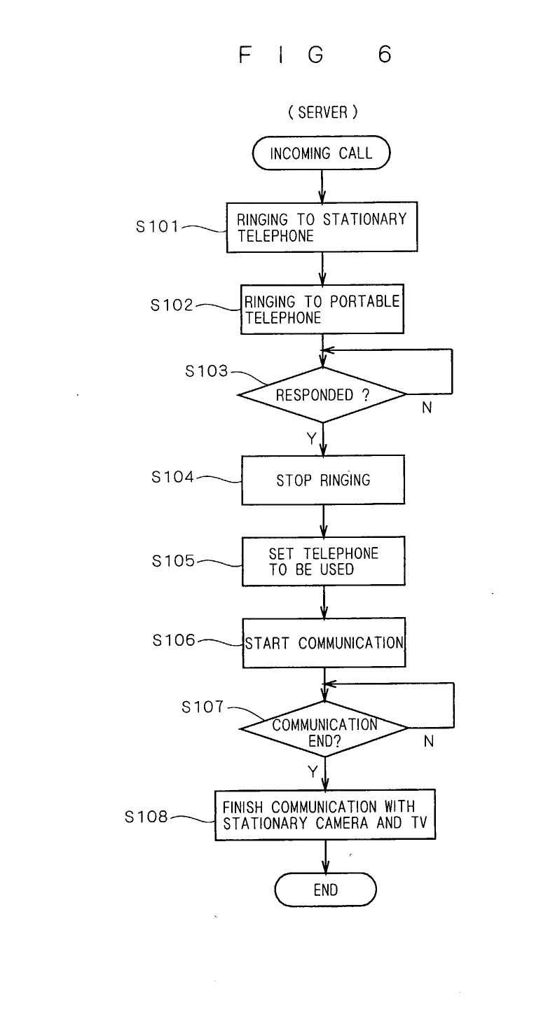

The operation unit 24 is a function unit having various keys and receiving an instruction inputted from the operator of the portable telephone 20. As will be described later, by operating the operation unit 24, a switch instruction signal is transmitted to the camera 30a (or 30b). The switch instruction signal switches a video signal to be transmitted to the other party between a video signal captured by the camera 25 of the portable telephone 20 and a video signal captured by the camera 30a installed in the room RM1. More concretely, a light beam such as an infrared ray is emitted as a predetermined switch instruction signal from the remote control light emitting unit 27 provided for the portable telephone 20 to a remote control light reception unit 37 (which will be described hereinafter, in FIG. 4) of the camera 30a.

A4. Camera TV Sets ST1 and ST2

The camera 30a, TV 40a of the camera TV set ST1 and the camera 30b and the TV 40b of the camera TV set ST2 will now be described.

First, the cameras 30a and 30b will be described. Since the cameras 30a and 30b have configurations similar to each other, the camera 30a will be mainly described here and the camera 30b will not be described in detail.

FIG. 4 is a functional block diagram showing the configuration of the camera 30a. As shown in FIG. 4, the camera 30a has a control unit 31, a communication unit 32, an image pickup unit 35, the remote control light reception unit 37, a zoom control unit 38, and a pan and tilt control unit 39.

The control unit 31 is constructed by a CPU and the like and is a function unit for controlling function units of the camera 30a. The communication unit 32 is a function unit for performing communications with the server 10 via the household network (LAN).

The image pickup unit 35 takes the form of, for example, a CCD camera having a relatively high resolution (for example, approximately 3000000 pixels). The camera 30a can perform zooming operation and the zooming operation is controlled by the zoom control unit 38. Further, the camera 30a can perform a panning operating and a tilting operation which are controlled by the pan and tilt control unit 39.

The remote control light reception unit 37 of the camera 30a receives a light beam (for example, infrared light) transmitted from the remote control light emitting unit 27 of the portable telephone 20 and receives a predetermined switch instruction signal or the like.

The TVs 40a and 40b will now be described. Since the TVs 40a and 40b have configurations similar to each other, the TV 40a will be mainly described, and the TV 40b will not be described in detail.

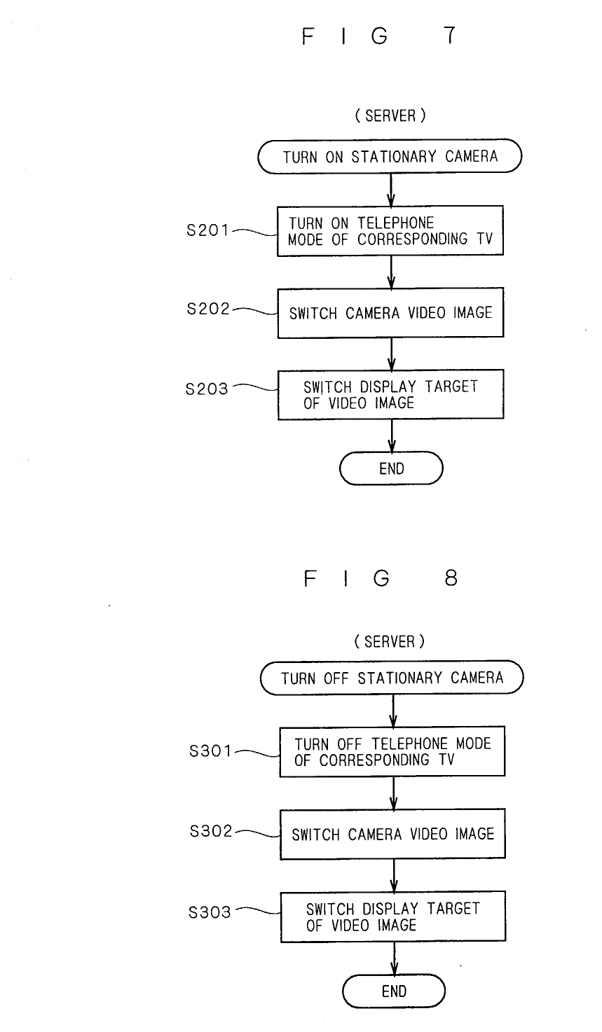

FIG. 5 is a functional block diagram showing the configuration of the TV 40a. As shown in FIG. 5, the TV 40a has a control unit 41, a communication unit 42, a display unit 46 and a remote control light reception unit 47.

The control unit 41 is constructed by a CPU and the like and is a function unit for controlling function units of the TV 40a. The communication unit 42 is a function unit for performing communication with the server 10 via a household network (LAN).

The display unit 46 takes the form of, for example, a display having a relatively high resolution of a high-vision digital TV or the like.

The remote control light reception unit 47 of the TV 40a receives a light beam (for example, infrared light) transmitted from the remote control light emitting unit 27 of the portable telephone 20 and receives a predetermined switch instruction signal or the like. The switch instruction signal enables to change a display target of a video signal from the other party from the display 26 to the TV 40a. Further, as will be described later, the display target of the video signal from the other party may be changed interlockingly with a switch signal of the camera 30a. More specifically, regarding the image pickup device, when a switch instruction signal instructing a switch from the camera 25 to the camera 30a is transmitted from the portable telephone 20, in response to the switch instruction signal, the display target of the video signal from the other party is automatically changed from the display 26 of the portable telephone 20 to the display unit 46 of the TV 40a. In such a manner, the combination of the camera 30a and the TV 40a can function as a part of the TV telephone system. Sound may be inputted/outputted by using the speaker 28 and the microphone 29 of the portable telephone 20.

The camera 30a is a stationary type camera, and the TV 40a is a stationary type TV. The camera 30a is disposed on the TV 40a. The camera 30b and the TV 40b of the camera TV set ST2 have a similar configuration.

A5. Basic Operation

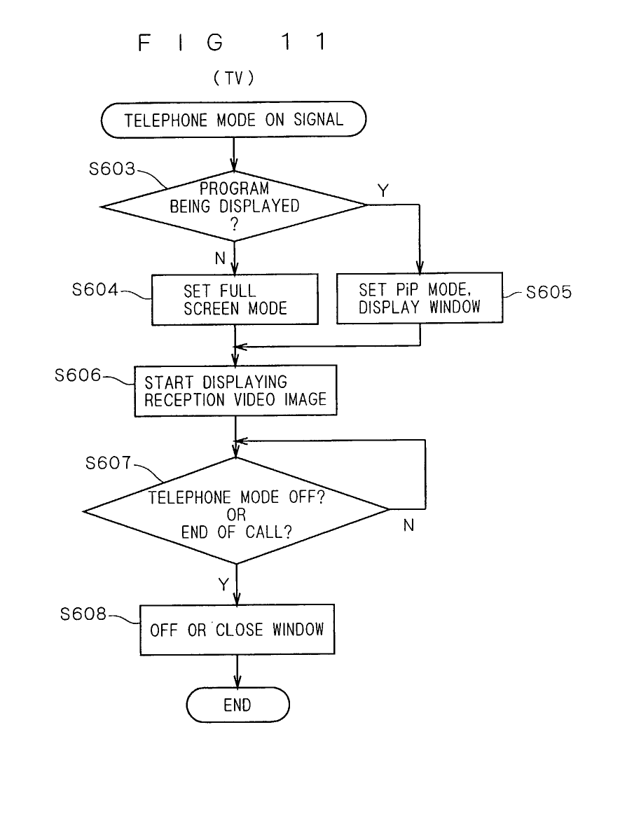

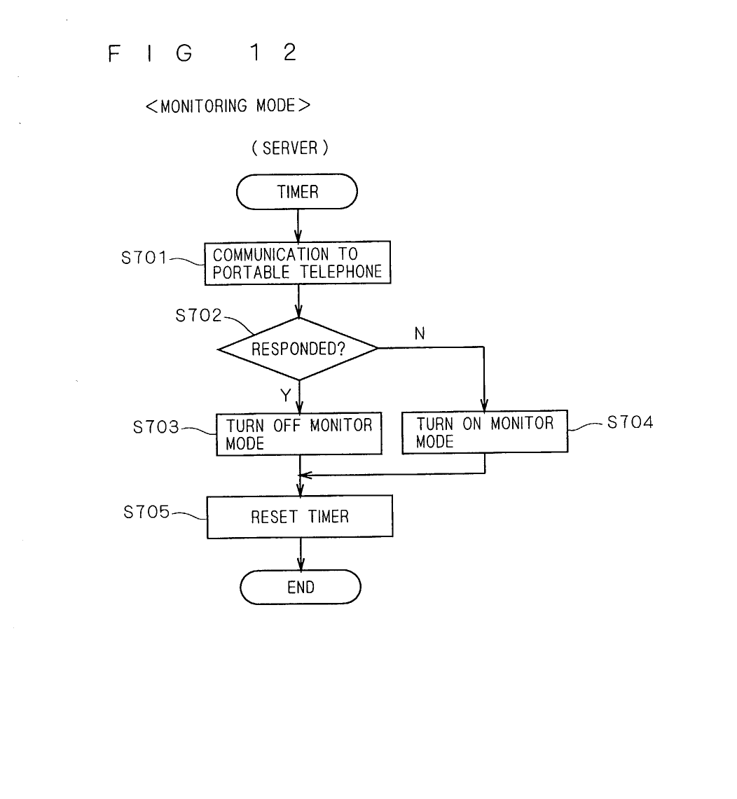

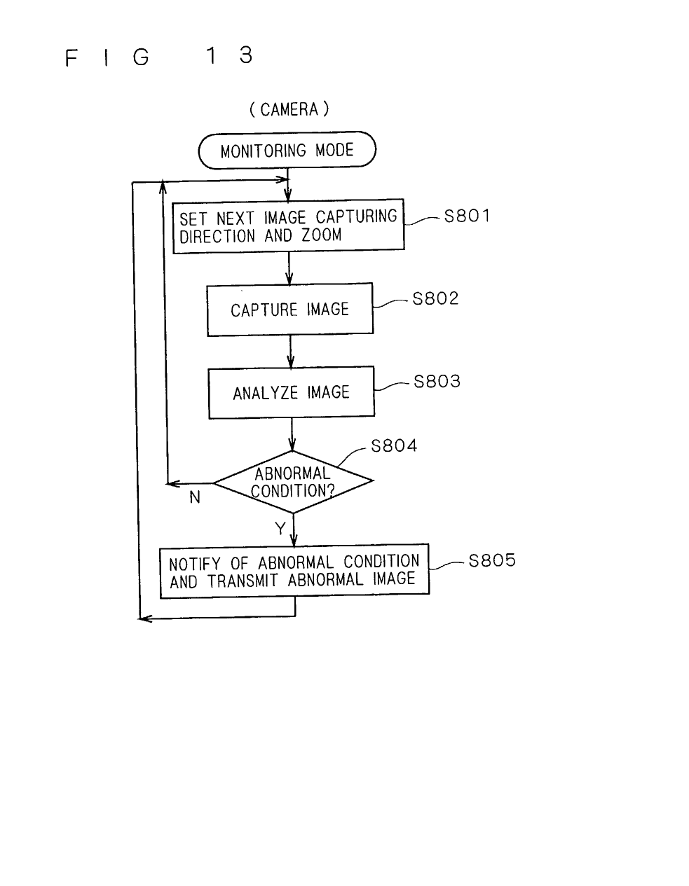

The operations in the TV telephone system lA will now be described by referring to the flowcharts of FIGS. 6 to 11. FIGS. 6 to 8 are flowcharts showing operations of the server 10. FIG. 9 is a flowchart showing operations of the portable telephone 20, FIG. 10 is a flowchart showing operations of the camera 30a (or 30b), and FIG. 11 is a flowchart showing operations of the TV 40a (or 40b).

First, referring to FIG. 6, the process of the server 10 in the case where the server 10 receives a call signal from an external other party will be described.

As shown in FIG. 6, when the server 10 receives a ringing signal, the server 10 transmits the ringing signal to the stationary telephones 60 and 70 in step S101, and transmits the ringing signal also to the portable telephone 20 in step S102. At this time, communication with the portable telephone 20 is performed by using the short-range radio communication. The portable telephone 20 and stationary telephones 60 and 70 generate an incoming call sound (ringing sound) in response to the rinsing signal. The operator who hears the incoming call sound performs an operation (responding operation) for making any of the portable telephone 20 and the stationary telephones 60 and 70 enter a call state. Accordingly, the portable telephone 20 or stationary telephone 60 or 70 returns a response signal to the server 10.

When the response signal from any of the telephones 20, 60 and 70 is received, the server 10 in a standby state (step S103) to the response signal stops transmission of the ringing signal to each of the telephones 20, 60 and 70 in step S104, makes a setting of connection to the telephone as the transmission source of the response signal (setting to determine which telephone to be used) in step S105, and starts a call with the telephone in step S106. The server 10 transmits the sound and video signals from the other party to the telephone which is set at the time of the connection setting, and transmits the sound and video signals from the telephone (ex. the portable telephone 20) to the other party.

For example, when a person who hears the incoming call sound picks up the portable telephone 20 and pushes the call button, the portable telephone 20 transmits the response signal to the server 10. The server 10 receives the response signal from the portable telephone 20, performs a setting operation so as to use the portable telephone 20, transmits the sound and video signals from the other party to the portable telephone 20 and also transmits sound and video signals from the telephone (ex. the portable telephone 20) to the other party.

The process in step S107 and subsequent steps in FIG. 6 is a connection finishing process which will be described hereinafter.

The operation of the portable telephone 20 on reception of the ringing signal will now be described by referring to FIG. 9.

The portable telephone 20 in a standby mode generates an incoming call sound in response to the ringing signal (step S102) from the server 10 in step S405 in FIG. 9.

Whether the operator of the portable telephone 20 performs an operation (responding operation) for shifting the portable telephone 20 into the call state or not is determined (step S406).

When it is determined in step S406 that the responding operation is not performed, the program advances to step S416 and whether the ringing signal from the server 10 is stopped or not is determined. If it is determined that the ringing signal from the server 10 is stopped, the portable telephone 20 stops the incoming sound (step S417), finishes the process, and shifts again to the standby mode for the following reason. The stop in the ringing signal from the server 10 denotes that the responding operation is performed by another telephone 60 (or 70) or the call generation from the other party is stopped. On the other hand, when it is determined that the ringing signal from the server 10 is not stopped, the program returns again to step S406.

When it is determined in step S406 that the responding operation is performed, the program advances to step S407 where the portable telephone 20 shifts to the call mode. Specifically, the portable telephone 20 receives the sound and video signals from the other party via the server 10, and transmits the sound and video signals from the portable telephone 20 to the other party via the server 10. At this time, the video signal from the other party is displayed on the display 26 of the portable telephone 20 and the video signal captured by the camera 25 of the portable telephone 20 is transmitted to the other party. The sound signal from the other party is output by using the speaker 28 of the portable telephone 20, and the sound signal collected by the microphone 29 of the portable telephone 20 is transmitted to the other party.

Referring now to FIG. 9, the process in the case of performing a call generating operation from the portable telephone 20 to an external party will be described.

In step S401, the portable telephone 20 transmits the number (telephone number) of the other party entered by the operator to the server 10. The server 10 performs an operation of generating a call to the number of the other party.

In step S402, whether there is a response from the other party or not is determined. When the server 10 receives the response from the other party, a notification indicating that the other party has responded is sent from the server 10 to the portable telephone 20. On receipt of the notification, the portable telephone 20 moves to step S407. On the other hand, if the notification is not received, the portable telephone 20 advances to step S403 and determines whether a call finishing operation has been performed by the operator of the portable telephone 20 or not. When it is determined that the call finishing operation has been performed, the call generating operation is finished. When it is determined that the call finishing operation has not been performed yet, the portable telephone 20 returns to step S402.

When the notification indicating that there is a response from the other party is received from the server 10 in step S402, the program advances to step S407 where the portable telephone 20 enters a call mode. The process in step S407 is as described above. The video signal from the other party is displayed on the display 26 of the portable telephone 20, and the video signal captured by the camera 25 of the portable telephone 20 is transmitted to the other party.

As described above, when the portable telephone 20 exists in the predetermined distance range from the server 10, the operator can make a call with a video image (plainly, “TV telephone call”) with the other party by using the portable telephone 20 always carried by the operator. The call is realized by performing the short-range radio communication between the portable telephone 20 and the server 10.

The following description will be given on assumption that the call state between the portable telephone 20 and the other party (communication destination) is established by the above operation.

A6. Switching Operation

During the call, the operator of the portable telephone 20 can perform a camera switching operation by using the portable telephone 20. Concretely, when the operator desires to transmit a video image of a high picture quality to the other party, the camera for image pickup can be switched to a camera of a high resolution. More specifically, the switching operation is realized by using a remote control function of the portable telephone 20. By still referring to FIG. 9, the switching operation will be described.

First, in step S408, whether the camera switching operation is performed or not is determined. In this case, the “camera switching operation” denotes an operation of switching the camera to be used for capturing a video signal to be transmitted to the other party. Concretely, the camera switching operation is an operation of selecting either the video signal from the camera 25 of the portable telephone 20 or the video signal from the camera 30a (or 30b) of the camera TV set ST1 (or TV set ST2) as a video signal to be transmitted to the other party. The camera switching operation is performed by selecting a predetermined selection option from a hierarchical menu displayed on the display 26 by the operator of the portable telephone 20.

In the case where it is determined that the switching operation is not performed, the program advances to an end determining process (which will be described hereinafter) in step S413. On the other hand, in the case where it is determined that the switching operation is performed, the program advances to step S409.

In step S409, the portable telephone 20 transmits the switch instruction signal to the camera from the remote control light emitting unit 27 to the remote control light reception unit 37 of the camera 30a in accordance with the camera switching operation. The light emission has a predetermined pattern indicative of the switching instruction. Preferably, to perform the switch reliably, the operator holds the portable telephone 20 so that the remote control light emitting unit 27 of the portable telephone 20 is directed toward the camera 30a. Although the case where the switch to the camera 30a will be described, the switch is made to the camera 30b in a similar manner.

In step S410, whether the present camera mode in the TV telephone system 1A is a “built-in camera mode” or an “external camera mode” is determined. The “built-in camera mode” is a mode in which a video signal captured by the camera 25 of the portable telephone 20 is transmitted to the other party. On the other hand, the “external camera mode” is a mode in which the video signal captured by the camera in the camera TV set ST1, that is, the camera 30a is transmitted to the other party.

If the present camera mode is not the built-in camera mode, the program advances to step S411 where the camera mode is switched to the built-in camera mode and the video signal captured by the camera 25 is transmitted to the server 10. On the other hand, if the present camera mode is the built-in camera mode, the program advances to step S412 where the present camera mode is switched to the external camera mode, and transmission of the video signal captured by the camera 25, which is built in the portable telephone, to the server 10 is stopped.

In the external camera mode, the video signal captured by the camera 25 is not transmitted from the portable telephone 20 to the server 10. Consequently, the data transmission amount related to the video signal in the short-range radio communication between the portable telephone 20 and the server 10 can be reduced. Usually, the sound and video signals are subjected to non-reversible compression at a high compression ratio to reduce the information amount and the resultant is transmitted. Consequently, when a predetermined communication capacity is regulated, even the quality of voice may deteriorate in order to transmit a video image. If the ratio of the sound data is increased when the video transmission is stopped in the short-range radio communication performed between the portable telephone 20 and the server 10, a call of a higher sound quality can be realized even in the regulation of the communication capacity.

After that, in step S413, the end determining process is performed. Whether the call has been finished or not is determined and, if the call continues, the program returns to step S408 where the process of detecting the presence or absence of the camera switching operation is performed again. On the other hand, when the call is finished, the program advances to a process in step S414 and subsequent steps which will be described hereinafter.

Switch from Built-in Camera to External Camera

Operations of the other devices with respect to the case of switching the built-in camera mode to the external camera mode will be described in detail. The switching operation is performed, for example, in the case where the operator desires to transmit a video image of a high picture quality to the other party.

First, with reference to FIG. 10, the process in the camera 30a will be described.

When the switch signal from the remote control light emitting unit 27 of the portable telephone 20 is received by the remote control light reception unit 37, the camera 30a in the standby mode recognizes that the present camera mode is switched to the “external camera mode”, and notifies the server 10 of activation of the camera (stationary camera) 30a and of the shift to the “external camera mode” (step S501). The signal regarding the notification will be also referred to as a “stationary camera ON signal” hereinafter. In step S502, the image capturing operation using the image pickup unit 35 of the camera 30a is started, and the captured video signal is transmitted to the server 10.

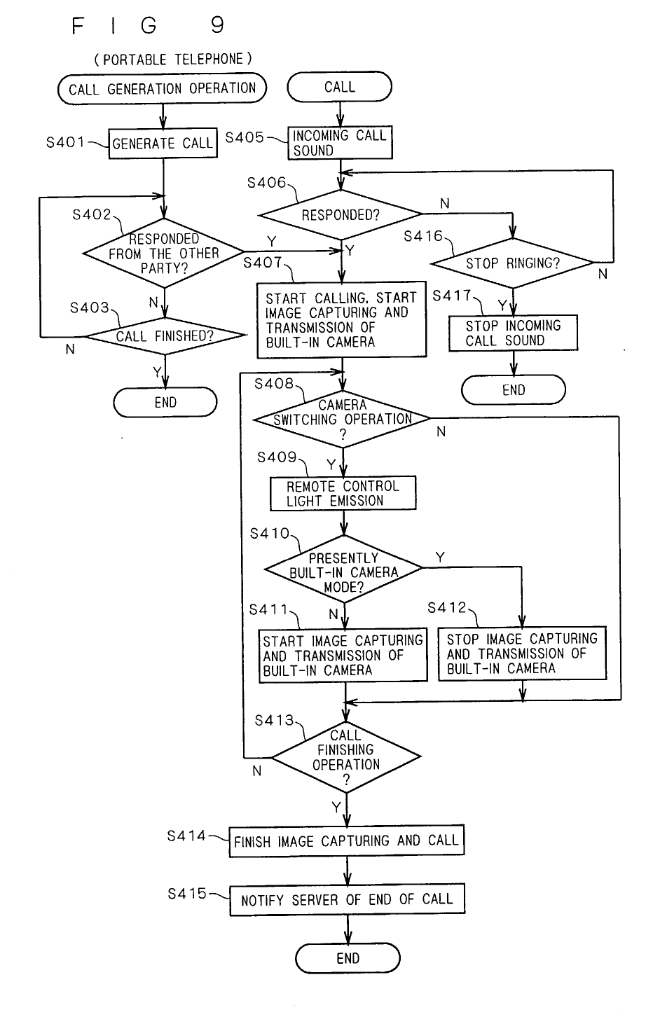

The operation of the server 10 which has received the notification will be described by referring to FIG. 7. FIG. 7 is a flowchart showing the operation of the server 10 which has received the “stationary camera ON signal”.

In step S201, the server 10 transmits an instruction of setting the TV 40a to a telephone mode toward the TV 40a corresponding to the camera 30a as the transmission source of the “stationary camera ON signal”. The signal related to the instruction will be referred to as a “telephone mode ON signal” hereinafter. As will be described later, the TV 40a functions as a part of the TV telephone in response to the telephone mode ON signal.

In step S202, the server 10 selects the video signal from the camera 30a as a video signal to be transmitted to the other party (communication destination) of the TV telephone, and transmits the selected video signal to the other party of the portable telephone 20.

In step S203, the server 10 switches a display target of the reception video image transmitted from the other party to the TV 40a. The server 10 transmits the reception video image to the TV 40a. At this time, the video image transmitted from the other party is not transmitted from the server 10 to the portable telephone 20. Therefore, the data transmission amount of the video signal in the short-range radio communication between the portable telephone 20 and the server 10 can be reduced. By increasing the ratio of the sound data, even in the regulation of the communication capacity, a call of a higher sound quality can be realized.

Further, the operation of the TV 40a which has received the “TV mode ON signal” will be described by referring to FIG. 11.

The TV 40a which has received the “telephone mode ON signal” determines in step S603 whether an image such as a TV image or a video image other than the TV telephone video image is being displayed on the display 46 of the TV 40a or not.

When the other image is not displayed at this time point, the program advances to step S604 where a screen mode of the TV 40a is set to a “full screen mode”. In the full screen mode, a video image regarding the TV telephone (video image from the other party) is displayed on the full screen of the TV 40a (step S606).

On the other hand, when another video image is displayed at this time point, the program advances to step S605 where the screen mode of the TV 40a is set to a “picture-in-picture (PiP) mode”. In the PiP mode, a window is opened in a part of a video image displayed until then, and a video image regarding the TV telephone (video image from the other party) is displayed in the window (step S606).

Switch from External Camera to Built-in Camera

The operation of the devices other than the portable telephone 20 will be described in detail with respect to the case where the present camera mode is switched, on the contrary, from the external camera mode to the built-in camera mode. The switching operation is performed, for example, in the case where the operator moves into a room where the stationary cameras 30a and 30b are not disposed.

First, the process in the camera 30a will be described by referring to FIG. 10.

In step S503, the camera 30a already in an active state waits for the switch signal from the remote control light emitting unit 27 of the portable telephone 20. When the switch signal from the remote control light emitting unit 27 of the portable telephone 20 is received by the remote control light reception unit 37 of the camera 30a again, the program advances to step S506 where it is recognized that the “external camera mode” is switched to the “built-in camera mode” and a notification is sent to the server 10 that the camera (stationary camera) 30a is set to a sleep mode and the present camera mode is switched to the “built-in camera mode” (step S506). The signal regarding the notification will be also referred to as a “stationary camera OFF signal” hereinafter. In step S505, the image pickup operation using the image pickup unit 35 of the camera 30a is stopped, and transmission of the video signal to the server 10 is also stopped.

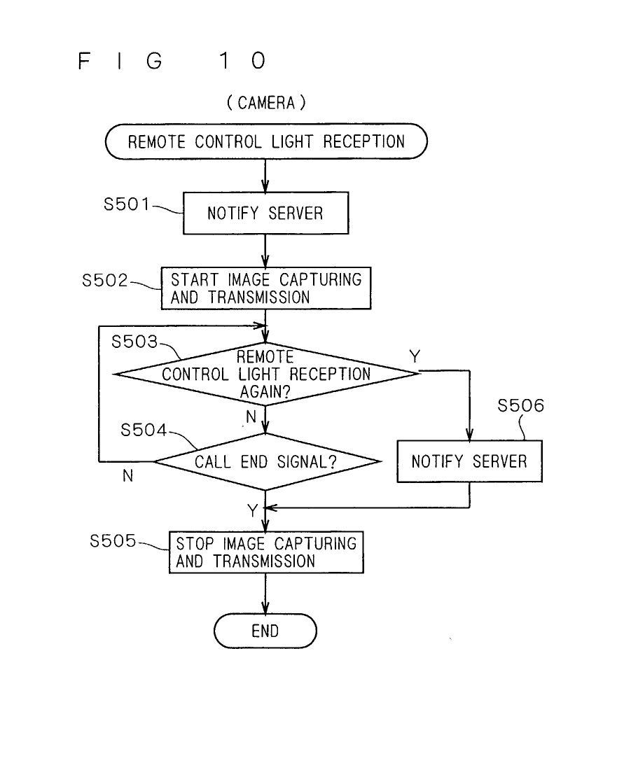

The operation of the server 10 which has received the notification will now be described by referring to FIG. 8. FIG. 8 is a flowchart showing the operations of the server 10 which has received the “stationary camera OFF signal”.

In step 301, the server 10 transmits an instruction of turning off the telephone mode of the TV 40a toward the TV 40a corresponding to the camera 30a as the transmission source of the “stationary camera OFF signal”. The signal regarding the instruction will be also referred to as a “telephone mode OFF signal” hereinafter. As will be described later, in response to the telephone mode OFF signal, the TV 40a stops the function as a part of the TV telephone.

In step S302, the server 10 selects a video signal from the camera 25 built in the portable telephone 20 as a video signal to be transmitted to the other party (communication destination) of the TV telephone, and transmits the selected video signal to the other party of the telephone.

In step S303, the server 10 switches the display destination of the reception video image transmitted from the other party from the TV 40a to the display 26. Concretely, the server 10 transmits the received video image to the portable telephone 20 by using the short-range radio communication.

Further, the operation of the TV 40a which has received the “telephone mode OFF signal” will be described by referring to FIG. 11.

In step S607, the TV 40a waits for the “telephone mode OFF signal”. When the TV 40a receives the “telephone mode OFF signal” in this state, the TV 40a advances to step S608.

In step S608, a process which is different according to the screen mode, which is the “full screen mode” or the “PiP mode”, is executed. Concretely, when the screen mode is the “full screen mode”, the TV 40a enters a sleep mode. When the screen mode is the “PiP mode”, the window is closed, the video image regarding the TV telephone (video image from the other party) is not displayed, and the video image displayed on the outside of the window is displayed in the full screen.

A7. Finishing Process and the Like

After the switching operation is performed while reflecting the intention of the operator, the call is finished. The process at the end of the call is as follows.

First, the operator performs the call finishing operation in step S413 (FIG. 9). In step S414, the portable telephone 20 performs a call finishing process. Concretely, transmission of the sound signal is stopped. In the case of the built-in camera mode, image pickup operation by the camera 25 is stopped, and display of the video image to the display 26 is also stopped. After that, the program advances to step S415 where the portable telephone 20 notifies the server 10 of the end of the call. Then the portable telephone 20 enters the standby mode. The signal for notifying of the end of the call is also referred to as a “call end notification signal”.

As shown in FIG. 6, when the server 10 receives the call end notification signal from the portable telephone 20 in step S107, the program advances to step S108 where the connection finishing process is performed.

In step S108, the server 10 notifies the stationary camera and the TV which are being used of the end of the call. For example, when the camera 30a and the TV 40a are in use, the call end notification signal is transmitted from the server 10 to the camera 30a and the TV 40a.

The camera 30a which has received the call end notification signal advances from step S504 in FIG. 10 to step S505 where the camera 30a stops the image capturing operation and the video signal transmitting operation and enters the sleep mode.

The TV 40a which has received the call end notification signal advances from step S607 in FIG. 11 to step S608 where the TV 40a stops the image capturing operation and the video signal transmitting operation and enters the sleep mode.

Although the operation of making a switch to the camera 30a has been described, the operation of making a switch to the camera 30b may be performed on condition that the camera 30b can receive a signal transmitted from the remote control light emitting unit 27 of the portable telephone 20 existing in the range in which the camera 30b can communicate with the server 10.

As described above, the server 10 according to the embodiment selects, as a video signal to be transmitted to the other party of the portable telephone 20, either the video signal from the camera 25 of the portable telephone 20 or the video signal from the camera (stationary camera) 30a of the camera TV set ST1, and transmits the selected video signal to the other party of the portable telephone 20 during the call of the portable telephone 20. Consequently, the range of selection regarding the video image to be transmitted to the other party is widened. In other words, by properly using the camera 25 of the portable telephone 20 and the stationary camera 30a, the cameras 25 and 30a can be effectively used. Particularly, since the resolution of the camera 30a is higher than that of the camera 25, when the video signal captured by the camera 30a is transmitted, a video image of a higher resolution (higher definition) as compared with that obtained by the camera 25 can be transmitted. Since the camera 30a is a stationary camera, as compared with the camera 25 of the portable telephone 20, occurrence of blurring is suppressed. Thus, a clearer video image can be transmitted to the other party.

The server 10 can perform a switching control of switching whether a reception video image transmitted from the other party during a call by the portable telephone 20 is displayed on the TV 40a or not. Consequently, a reception video image can be displayed on the TV 40a other than the display 26 provided for the portable telephone 20, so that the range of selection regarding the target on which the video image from the other party is displayed can be widened. Particularly, the TV 40a has a screen larger than the display 26, so that the video image from the transmitter can be displayed largely.

When the video signal from the camera 30a is selected as a video signal to be transmitted to the other party of the portable telephone 20, the reception video image transmitted from the other party is displayed on the TV 40a. Thus, both the camera 30a and the TV 40a can be used as a set of the image capturing and display system in the TV telephone system.

A8. Monitoring Mode

The cameras 30a and 30b in the TV telephone system 1A are used as image capturing devices in the TV telephone and also monitor cameras. The monitoring operation will be described hereinafter.

Concretely, the server 10 inquires periodically the portable telephone 20 by using the short-range radio communication whether communication can be performed or not to confirm the communicatable state. If there is no response from the portable telephone 20 to the inquiry made by the short-range radio communication, it is determined that the operator of the portable telephone 20 carries the portable telephone 20 and is outside. Based on the determination, when the short-range radio communication cannot be performed between the server 10 and the portable telephone 20, the server 10 uses the cameras 30a and 30b as monitor cameras. The operation mode of the cameras 30a and 30b is switched from a mode in which the cameras are used as image capturing devices in the TV telephone (hereinafter, also referred to as “TV telephone mode”) to a mode in which the cameras 30a and 30b are used as monitor cameras (hereinafter, referred to as “monitor camera mode”). Video images of the room captured by the cameras 30a and 30b are stored in the server 10 and transferred to the portable telephone 20 via the Internet or the like.

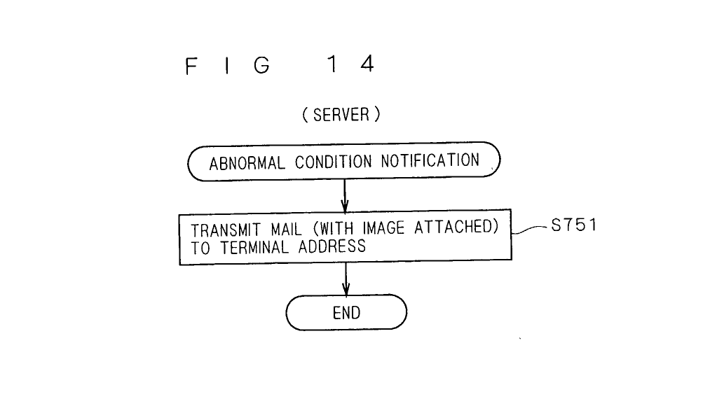

The operation will be described in detail hereinafter with reference to the flowcharts of FIGS. 12 and 13. FIG. 12 is a flowchart showing operations of the server 10, and FIG. 13 is a flowchart showing operations of the camera 30a.

First, the server 10 performs an operation of determining whether the cameras 30a and 30b are allowed to function as monitor cameras or not as shown in FIG. 12.

Concretely, the server 10 inquires periodically the portable telephone 20, by using the short range radio communication, of whether communication can be performed or not (step S701 in FIG. 12) and recognizes whether the portable telephone 20 is in the communicatable state or not (step S702). The inquiring operation in step S701 is executed in response to a timer signal generated each time a predetermined period elapses. As a result, the mode setting operation in steps S701 to S705 is executed every predetermined cycle.

When the portable telephone 20 responds to the inquiry by the short-range radio communication, it is found that the distance from the server 10 to the portable telephone 20 is within a predetermined range, the monitoring mode is turned off (step S703), and the timer is reset (step S705). In step S703, the server 10 transmits a control signal to turn off the monitor mode, in other words, a control signal of setting the operation mode to the “TV telephone mode” toward the cameras 30a and 30b, and the cameras 30a and 30b actually set the operation mode to the “TV telephone mode” in accordance with the control signal. Preferably, to suppress power consumption, the cameras 30a and 30b are in a sleep mode when unused.

On the other hand, when there is no response from the portable telephone 20 to the inquiry by the short range radio communication, it can be understood that the distance from the server 10 to the portable telephone 20 is not within the predetermined range, plainly, the portable telephone 20 does not exist near the server 10. Consequently, it is determined that the operator of the portable telephone 20 carries the portable telephone 20 and is outside (step S704). Based on such determination, when the short-distance radio communication between the server 10 and the portable telephone 20 cannot be performed, the server 10 changes the monitoring mode to an ON state and uses the cameras 30a and 30b as monitor cameras. In other words, the operation mode of the cameras 30a and 30b is switched from the “TV telephone mode” to the “monitor camera mode”. Concretely, in step S704, the server 10 transmits a control signal to turn on the monitor mode, in other words, a control signal for setting the operation mode to the “monitor camera mode” toward both of the cameras 30a and 30b via the household network. The cameras 30a and 30b actually set the operation mode to the “monitor camera mode” in accordance with the control signal. After that, the program advances to step S705 and the timer is reset.

With reference to FIG. 13, the operation of the camera 30a which receives a mode change instruction to the “monitor camera mode” (in other words, a control signal to set the operation mode to the “monitor camera mode”) will be described. Although the operation of the camera 30a will be described here, the camera 30b operates similarly.

In step S801 in FIG. 13, the camera 30a executes an image capturing operation in accordance with a preset procedure. The image capturing direction and the magnification of the camera 30a for obtaining a video image are preset. For example, the image capturing direction can be set so as to obtain a plurality of video images (still images in this case) at wider angles while moving the camera 30a in the horizontal direction every predetermined angle. The pan and tilt control unit 39 (FIG. 4) controls the posture of the camera 30a by driving an actuator built in the camera 30a, thereby realizing the preset initial image capturing direction. Further, the zoom control unit 38 (FIG. 4) controls the zoom lens in a similar manner, thereby realizing the preset initial magnification. In step S801, a preparing operation to obtain an image in a predetermined image capturing direction at a predetermined magnification is performed by the pan and tilt control unit 39 and the zoom control unit 38. After that, in step S802, an actual image capturing operation is performed.

In step S803, a suspicious object is detected by performing an image analyzing operation. Concretely, a still image obtained at present and a still image of the same scene captured previously are compared with each other. If there is a different point (change) to a predetermined degree or more between them, the possibility that a suspicious character breaks in the room, that is, abnormal condition is determined in step S804. As long as a suspicious character does not break in the room where the camera 30a is disposed, the different point is not supposed to exist between the images captured from the same image capturing direction at the same magnification.

If no abnormal condition is determined in step S804, the program returns to step S801 where an operation of capturing the next image is performed. Specifically, the image capturing direction and the magnification are changed to the next set values, and the program shifts to an operation of capturing a new still image.

On the other hand, when presence of an abnormal condition is determined in step S804, the program advances to an abnormal condition notifying operation in step S805. In step S805, the camera 30a notifies the server 10 of the fact that the abnormal condition is detected, and transmits a still image in which an abnormal condition is detected to the server 10. The program returns to step S801 where the next image capturing operation is performed.

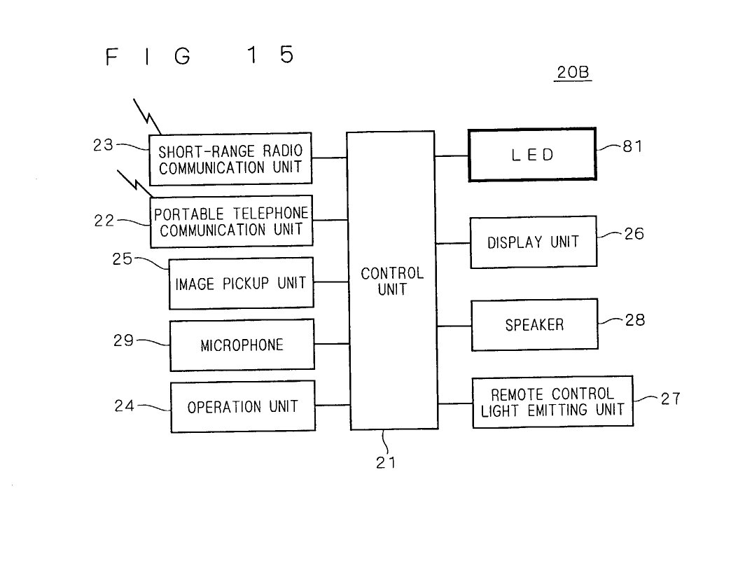

The server 10 which has received the notification of the abnormal condition from the camera 30a transmits a mail, to which a still image of which abnormal condition is detected is attached, to the mail address of the portable telephone 20 in step S751 in FIG. 14. By receiving the mail, the operator of the portable telephone 20 can recognize that something abnormal occurs in an absent master's home. Since the abnormal condition notification is sent by a mail, even in the case where the portable telephone 20 performs the communication function as a regular radio portable telephone via a base station (not as a short-range radio communication tool) on the outside, an influence can be prevented from being directly exerted on a call by the portable telephone 20 and the like.

Although the operation of the camera 30a has been described above, the operation of the camera 30b is similar to the above. Although an instruction of shifting to the monitor camera mode is transmitted to the two cameras 30a and 30b, it is also possible to transmit an instruction of shifting to the monitor camera mode to all or a part of three or more stationary cameras, or transmit an instruction of shifting to the monitor camera mode only to one camera 30a (or 30b).

As described above, the server 10 can control the operation mode of the cameras 30a and 30b so as to be switched between the “TV telephone mode” and the “monitor camera mode”, so that the cameras 30a and 30b provided separately from the portable telephone 20 can be used as a high-quality image capturing device (in the TV telephone) and also as monitor cameras for monitoring the ambient condition (such as a condition in a room). Thus, the cameras 30a and 30b can be effectively used.

When communication with the portable telephone 20 by the short-distance radio communication cannot be performed, the server 10 does not use the cameras 30a and 30b as the image capturing devices in the TV telephone so that the server 10 performs a control of switching the operation mode so that the cameras 30a and 30b are used as monitor cameras. By performing such rational switching operation, the efficiency of use of the cameras 30a and 30b can be improved. That is, the cameras 30a and 30b can be effectively used.

In the embodiment, the case of notifying the portable telephone 20 of occurrence of an abnormal state by a mail when an abnormal condition is detected in accordance with images captured by the cameras 30a and 30b and the like has been described. It is also possible to use the cameras 30a and 30b as monitor cameras by using another method. For example, the operator of the portable telephone 20 can control the cameras 30a and 30b by a remote control using the portable telephone 20. The operator performs an image capturing operation by the cameras 30a and 30b by using the portable telephone 20, and can transmit an instruction of sending back the video image to the portable telephone 20. The camera 30a which receives such an instruction via the server 10 may transmits the captured video image to the portable telephone 20 via the server 10 in accordance with the instruction.

Although the case that the server 10 notifies the portable telephone 20 of occurrence of an abnormal condition by a mail has been described in the embodiment, the present invention is not limited to the case. For example, it is also possible to store a captured image used for abnormal condition detection in the server 10 and transmit the captured image to the portable telephone 20 or the like in accordance with a request from the operator. In the case where the degree of urgency is very high, the server 10 does not send a notification by mail but may make a call to the portable telephone 20 to notify of occurrence of an abnormal condition by an automatic voice message like “a suspicious character is found in your home” and the operator may access the server 10 to receive the captured image in accordance with the notification.

Further, in the embodiment, when short-range radio communication between the server 10 and the portable telephone 20 cannot be performed, the cameras 30a and 30b are used as monitor cameras. It is also possible to use the cameras 30a and 30b as monitor cameras without using the portable telephone 20. For example, when the operator of the portable telephone 20 left home without carrying the portable telephone 20 with him/her, the operator transmits a call signal to the server 10 by using a telephone or the like from the outside, thereby enabling the cameras 30a and 30b to be used as monitor cameras.

B. Second Embodiment

A TV telephone system 1B according to a second embodiment will now be described.

In the first embodiment, the case of performing a switching operation of determining which one of the plurality of the cameras 25 and 30a (30b) to be used as an image pickup device of a TV telephone (plainly, camera switching operation) in accordance with a switching operation using the portable telephone 20 as a remote controller has been described. In the second embodiment, a case of performing a switching operation by recognizing the position of a portable telephone by using the cameras 30a and 30b (a case of automatically performing the switching operation) will be described.

Since the TV telephone system 1B has a configuration similar to that of the TV telephone system 1A, the different points will be mainly described hereinafter.

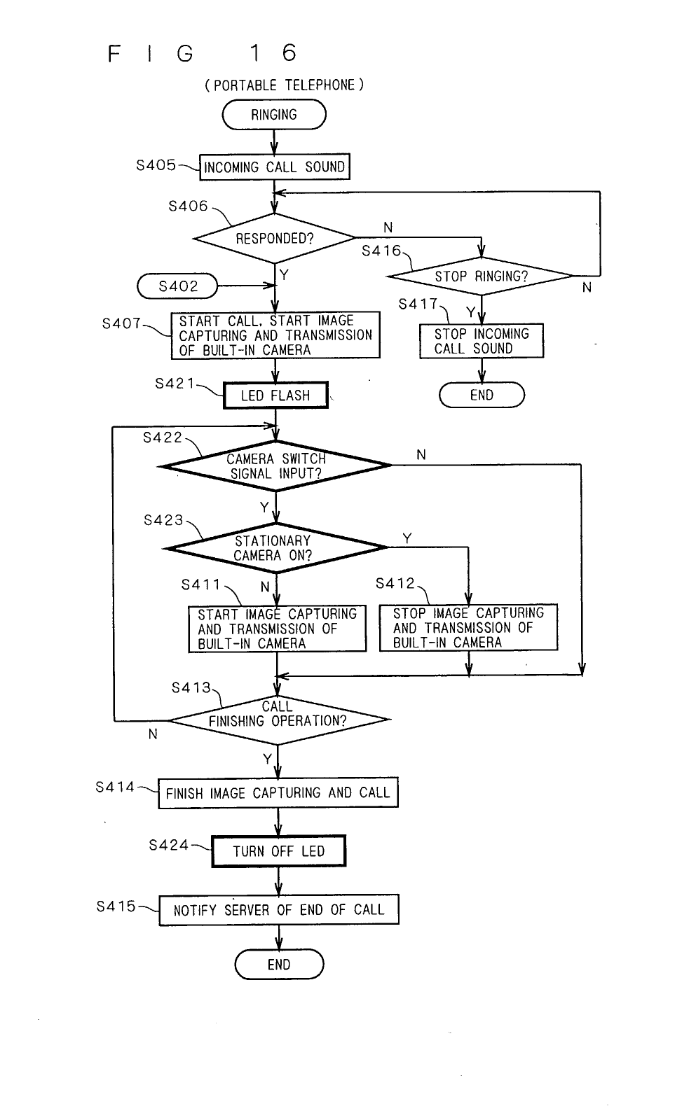

FIG. 15 is a diagram showing the configuration of a portable telephone 20B according to the second embodiment. As shown in FIG. 15, the portable telephone 20B has an LED 81. The LED 81 is provided at the tip of the antenna of the portable telephone 20B and flashes in a predetermined pattern during a call. It is assumed that the call is established by using the short-range communication function between the portable telephone 20B and the server 10.

Each of the stationary cameras 30a and 30b operates during a call of the portable telephone 20B and captures a video image by using its image pickup unit 35 and the like. Each of the cameras 30a and 30b determines whether the portable telephone 20B exists in the field of view or not depending on whether the flash pattern can be detected or not in accordance with the captured video image.

When it is determined that the portable telephone 20B does not exist in the field of view of the cameras 30a and 30b, a video image transmitted from the other party is displayed on the display 26 of the portable telephone 20B and a video image captured by the built-in camera 25 of the portable telephone 20B is transmitted to the other party.

On the other hand, when it is determined that the portable telephone 20B exists in the field of view of either the camera 30a or 30b, the video image transmitted to the other party is switched to a video image captured by the camera other than the built-in camera 25. For example, when the camera 30a detects the portable telephone 20B in its field of view, a video signal from the camera 30a is transmitted to the other party via the server 10. In this case, a display target of a reception video image transmitted from the other party is changed from the display 26 of the portable telephone 20B to the TV 40a disposed close to the camera 30a. That is, the reception video image is not displayed on the display 26 but is displayed only on the TV 40a. The display target of the reception video image is not limited to the above. The reception video image transmitted from the other party may be displayed on the TV 40a disposed close to the camera 30a and also continuously on the display 26 of the portable telephone 20B.

Therefore, when the operator of the portable telephone 20B carries the portable telephone 20B and moves to a room where the stationary cameras 30a and 30b are not installed, the camera 25 built in the portable telephone 20B automatically starts and an image captured by the camera 25 is transmitted to the other party.

On the other hand, when the operator of the portable telephone 20B carries the portable telephone 20B and moves to a room where the stationary camera 30a is installed, the camera 30a automatically starts and a high-quality image captured by the camera 30a is transmitted to the other party. The case where the operator moves in a room where the camera 30b is installed is similar to the above and an image captured by the camera 30b is transmitted to the other party.

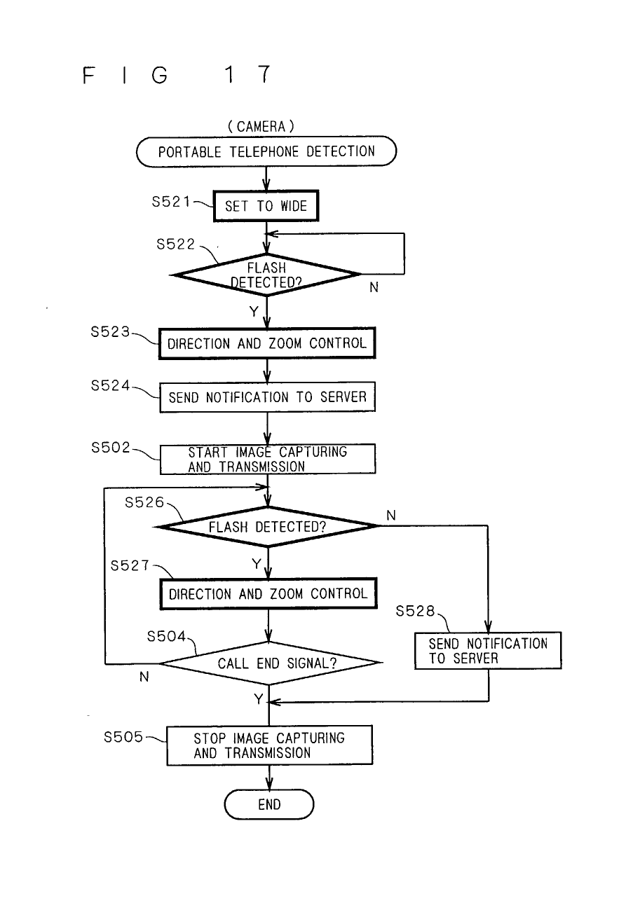

The operation will be described in detail with reference to flowcharts of FIGS. 16 and 17 and the like. FIG. 16 is a flowchart showing the operation of the portable telephone 20B, and FIG. 17 is a flowchart showing the operation of the camera 30a. FIGS. 16 and 17 are similar to FIGS. 9 and 10, respectively, and the same reference numerals are designated to steps in which similar operations are performed. The basic operation of the server 10 is substantially the same as that in the flowchart of FIG. 6, so that it is not shown.

When a call between the portable telephone 20B and the other party is established (step S407 in FIG. 16), the portable telephone 20B makes the LED 81 provided at the tip of the antenna flash (step S421). The server 10 instructs each of the cameras 30a and 30b to perform a process (FIG. 17) of determining whether the portable telephone 20B exists in its field of view or not.

As shown in the flowchart of FIG. 17, first in step S521, each of the cameras 30a and 30b sets a zoom to the wide side (wide angle end) to increase the possibility that the portable telephone 20B is caught in the field of view. By the operation, the subject can be captured in a wider range. Although the operation of the camera 30a will be described in the following, the operation of the camera 30b is similar.

In step S522, whether the LED 81 flashes in a captured video image or not is detected. When the flash is not detected, the operation of detecting flash of the LED 81 is continued until the call is finished. When flash is detected, the program advances to step S523 where the camera 30a is directed to the flash portion by a pan and tilt control, and an image is enlarged by using the flash portion as a reference at a predetermined magnification (zoom magnification). By the operation, for example, the upper part of the operator can be displayed in a whole video image. In the portable telephone 20B, it is also possible to dispose two LEDs 81 at a predetermined interval and, by calculating the distance between the two LEDs 81 in a captured video image, to determine the magnification more properly.

In step S524, the portable telephone 20B exists in the field of view of the camera 30a. Accordingly, the camera 30a notifies the server 10 of a state that the camera 30a is activated as an image pickup device in the TV television system 1B (plainly, the camera 30a becomes active). In step S502, an image pickup operation is started by using the image pickup unit 35 of the camera 30a, and a captured video signal is transmitted to the server 10. After that, the video image captured by the camera 30a is transmitted to the other party via the server 10 as shown in step S202 in FIG. 7.

Further, the camera 30a continues capturing the flash state during the call. Consequently, in step S526, whether flash is continuously detected or not is determined. If the flash is detected, the pan and tilt control and the zoom control are performed so as to always follow the flash portion (step S527). By the operation, even when the operator of the portable telephone 20B moves in the room during the call, as long as the operator exists in the field of view of the camera 30a, the position can be followed. The operation is continued until the end of the call.

When the flash of the LED 81 cannot be captured (detected) during the call, the program advances from step S526 to step S528, and the server 10 is notified of the state that the camera 30a stops the function as the image pickup device since the flash cannot be detected (plainly, the camera 30a becomes inactive). Accordingly, a video image captured by another camera (for example, a video image captured by the built-in camera 25 of the portable telephone 20B (step S411 in FIG. 16)) is transmitted to the other party.

Referring again to FIG. 16, the operation of the portable telephone 20B will be described.

In step S422, the portable telephone 20B determines whether a camera switching signal exists or not. The camera switching signal denotes a signal of switching the camera for capturing a video image to be transmitted to the other party, and is a signal transmitted from the server 10 to the portable telephone 20B. The camera switching signal is generated according to a notification to the server 10 of whether each of the cameras 30a and 30b functions as an image pickup device or not. The camera switching signal also includes information indicating the camera which is presently active (active camera information).

When the camera switching signal is received, in step S423, the portable telephone 20B checks whether the cameras 30a and 30b are ON or not on the basis of the active camera information included in the camera switching signal.

When either the camera 30a or 30b is active, the program advances to step S412 where the image capturing operation by the built-in camera 25 of the portable telephone 20B and the operation of transmitting a video image to the server 10 are stopped. At this time, the video signal captured by the camera 30a or 30b, which is an external camera, is started to transmit to the server 10. When both of the cameras 30a and 30b are inactive, the program advances to step S411 where the image capturing operation by the built-in camera 25 of the portable telephone 20B and the operation of transmitting a video image to the server 10 are started.

By the operation, while following the flash of the LED 81 of the portable telephone 20B by the cameras 30a and 30b, the camera to function as the image pickup device in the TV telephone can be properly switched.

The server 10 transmits a video image selected according to the existing position of the portable telephone 20B from video images captured by the plurality of cameras 25, 30a and 30b to the other party of the portable telephone 20B

Concretely, when both of the stationary cameras 30a and 30b are not active (inactive), the server 10 transmits a video image captured by the built-in camera 25 of the portable telephone 20B to the other party. Concretely, when the operator carrying the portable telephone 20B is in a room where the cameras 30a and 30b are not installed, the video image captured by the built-in camera 25 is transmitted to the other party.

When at least one of the stationary cameras 30a and 30b is active, the server 10 transmits a video image captured by the active camera to the other party. For example, when the operator carrying the portable telephone 20B is in a room RM1, a video image captured by the camera 30a is transmitted to the other party. When the operator carrying the portable telephone 20B is in a room RM2, a video image captured by the camera 30b is transmitted to the other party.

When both of the cameras 30a and 30b are active for the reason such that the cameras 30a and 30b are installed in the same room, it is sufficient for the server 10 to select a camera of which video image is transmitted to the other party in accordance with preset priority. For example, in the case where the priority is determined in order of the camera 30a and the camera 30b, if both of the cameras 30a and 30b are active, the server 10 selects the camera 30a and transmits a video image captured by the camera 30a to the other party of the portable telephone 20B.

When the call is finished, the program advances to step S424 where the LED 81 of the portable telephone 20B is turned off. By turning off the LED 81 when a call is not made, power consumption can be suppressed.

Further, in step S415, the portable telephone 20B notifies the server 10 of the end of the call.

In step S505 (FIG. 17), the camera 30a stops the image capturing operation using the image pickup unit 35 of the camera 30a and stops transmission of the video signal to the server 10.

As described above, according to the second embodiment, effects similar to those of the first embodiment can be obtained. In addition, the position of the portable telephone 20B is detected by using the cameras 30a and 30b, and the camera of which video image is to be transmitted to the other party is properly selected and determined from the built-in camera 25 in the portable telephone 20B and the stationary cameras 30a and 30b of high resolution in accordance with the position of the portable telephone 20B.

C. Others

In the switching process in step S203 (FIG. 7) in the embodiment, a reception video image transmitted from the other party is not displayed on the display 26 of the portable telephone 20. The present invention is not limited to the method but the video image may be displayed on both of the display 26 and the TV 40a.

In each of the above described embodiments, a video image transmitted as a video signal may be a still image or a motion image.

In each of the above-described embodiments, the case where the server 10 as a general computer is used as a controller of the TV telephone system 1A has been described, but the present invention is not limited to the case. For example, a home server taking the form of a dedicated hardware device such as a set top box (STB) may be provided as the controller of the TV telephone system 1 A.

Although an LAN using a cable such as 10BASE-T is described as an example of the household network in each of the above described embodiments, a radio LAN or the like may be also used.

While the invention has been shown and described in detail, the foregoing description is in all aspects illustrative and not restrictive. It is therefore understood that numerous modifications and variations can be devised without departing from the scope of the invention.

What is claimed is:

1. A program product which can be read by a computer provided in a controller of a television telephone system including a telephone having a first camera, and a second camera, the program product comprising the instructions of:
selecting, as a video signal to be transmitted to the other party of the telephone, one of a video signal from the first camera and a video signal from the second camera; and
transmitting the selected video signal to the other party of the telephone during a call of the telephone.

2. The program product according to claim 1, wherein
resolution of the second camera is higher than that of the first camera.

3. The program product according to claim 1, wherein
the video signal is selected in accordance with a signal generated from the telephone.

4. The program product according to claim 1, wherein
the video signal is selected in accordance with the position of the telephone.

5. The program product according to claim 1, wherein
the television telephone system has a first display device provided for the telephone and a second display device provided separately from the telephone,
each of the first and second display devices can display a reception video image transmitted from the other party, and
the program product further comprises an instruction of switching a display target of the reception video image transmitted from the other party between the first and second display devices during a call by the telephone.

6. The program product according to claim 5, further comprising an instruction of:
displaying the reception video image transmitted from the other party on the second display device when the video signal from the second camera is selected as a video signal to be transmitted to the other party of the telephone.

7. A program product which can be read by a computer provided in a controller of a television telephone system including a telephone and a camera provided separately from the telephone, the program product comprising the instructions of:
determining whether radio communication can be performed between the controller and the telephone; and
switching an operation mode of the camera to a monitoring mode in which the camera is used as a monitor camera when the radio communication cannot be performed between the telephone and the controller.

8. The program product according to claim 7, wherein
the telephone has a display device for displaying a video signal transmitted from the other party, and
the program product further comprises an instruction of transmitting captured image data to the telephone when an abnormal condition is detected by the camera executing a monitoring mode.

9. The program product according to claim 7, further comprising the instruction of:
executing automatic sound communication which generates sound notifying an occurrence of the abnormal condition when the abnormal condition is detected by the camera executing the monitoring mode.

10. A program product which can be read by a computer provided in a controller of a television telephone system having a camera, the program product comprising the instructions of:
determining whether the operator requests setting of a monitor mode in which the camera is used as a monitor camera or not; and
switching an operation mode of the camera to the monitor mode when the operator requests setting of the monitoring mode.
